(19) United States
(12) Patent Application Publication
(10) Pub. No.: US 2019/0193659 A1
(43) Pub. Date: Jun. 27, 2019

(54) ACCIDENT INFORMATION COLLECTION SYSTEM, AND ACCIDENT INFORMATION COLLECTION METHOD

(71) Applicant: Mitsubishi Electric Corporation, Tokyo (JP)

(72) Inventors: Kazuyuki MIYAZAWA, Tokyo (JP); Shunichi SEKIGUCHI, Tokyo (JP); Hideaki MAEHARA, Tokyo (JP); Yoshimi MORIYA, Tokyo (JP); Akira MINEZAWA, Tokyo (JP); Ryoji HATTORI, Tokyo (JP); Momoyo HINO, Tokyo (JP); Tomoya SAWADA, Tokyo (JP); Naohiro SHIBUYA, Tokyo (JP)

(73) Assignee: Mitsubishi Electric Corporation, Tokyo (JP)

(21) Appl. No.: 16/307,221

(22) PCT Filed: Jul. 7, 2016
(86) PCT No.: PCT/JP2016/070111

§ 371 Date: Dec. 5, 2018

(51) Int. Cl. B60R 21/0132; G07C 5/00; B60R 21/0136

(52) U.S. Cl. CPC B60R 21/0132; B60R 2021/0027; B60R 21/0136; G07C 5/008

(57) ABSTRACT

An information processing unit (32) collects accident information from a vehicle-mounted device (2) existing in a periphery of a site of an accident indicated by accident information stored in a storage unit (31), by controlling a communication unit (30).

### TECHNICAL FIELD

The present invention relates to an accident information collection system, a vehicle-mounted device, and an accident information collection method for collecting information on a traffic accident.

### BACKGROUND ART

Storing a video of the periphery of a vehicle and the like when the vehicle encounters a traffic accident is extremely important for a party concerned in the accident or a third party organization to know behavior of the vehicle, a pedestrian, and the like involved in the accident before and after the accident. As a device for storing an accident video, for example, a driving recorder is known for capturing a video ahead of the vehicle with a camera mounted near a rearview mirror in the vehicle, and storing in the storage device the video of a certain period before and after the accident is detected.

In recent years, in order to implement advanced driving assistance and automatic driving, examples are increasing of performing sensing of the periphery of the vehicle with a camera. In addition, it is also considered that a device mounted on each vehicle communicates with another vehicle, an information center, or a roadside facility to exchange information.

For example, Patent Literature 1 describes an accident information collection system for transmitting accident information including a video of the periphery of a vehicle captured by a vehicle-mounted camera to an information collection center when an abnormality is detected in the vehicle behavior.

### CITATION LIST

### Patent Literature

Patent Literature 1: JP 2007-293536 A

### SUMMARY OF INVENTION

### Technical Problem

In the accident information collection system described in Patent Literature 1, the information collection center collects accident information only from a vehicle having directly encountered a traffic accident. The video included in the accident information is captured in a field of view of the camera included in the vehicle having directly encountered the traffic accident.

Therefore, in the accident information collection system described in Patent Literature 1, a video can be obtained from only a limited viewpoint such as the front of the vehicle. In this case, even if an accident occurs in the side or the rear of the vehicle, there is a possibility that the situation of the accident is not captured in the video at all. In addition, when the capturing function of the camera is lost due to the shock of the accident, the video of the periphery of the vehicle cannot be obtained at all.

The present invention has been made to solve problems described above, and it is an object to provide an accident information collection system, a vehicle-mounted device, and an accident information collection method capable of collecting videos of various viewpoints of a traffic accident.

### Solution to Problem

An accident information collection system according to the present invention includes a communication unit, a storage unit, and an information processing unit.

The communication unit communicates with one or more vehicle-mounted devices for each generating accident information including information indicating a location and a video of an accident having occurred in a vehicle or the periphery of the vehicle. The storage unit stores accident information received from at least one of the vehicle-mounted devices by the communication unit. The information processing unit collects accident information from at least another one of the vehicle-mounted devices existing in a periphery of a site of an accident indicated by the accident information stored in the storage unit, by controlling the communication unit.

### Advantageous Effects of Invention

According to the present invention, since accident information including videos of an accident is collected from a vehicle existing in the periphery of the accident site in addition to a vehicle having directly encountered the accident, videos of various viewpoints of a traffic accident can be collected.

### BRIEF DESCRIPTION OF DRAWINGS

FIG. 1 is a block diagram illustrating a configuration example of an accident information collection system according to a first embodiment of the present invention.

FIG. 2 is a block diagram illustrating a hardware configuration of a vehicle-mounted device in the first embodiment.

FIG. 3 is a block diagram illustrating a hardware configuration of an information center device in the first embodiment.

FIG. 4 is a flowchart illustrating operation of the vehicle-mounted device in the first embodiment.

FIG. 5 is a diagram illustrating an example of accident information in the first embodiment.

FIG. 6 is a flowchart illustrating operation of the information center device in the first embodiment.

FIG. 7 is a flowchart illustrating operation of an information center device according to a second embodiment of the present invention.

FIG. 8 is a diagram illustrating a relationship between an accident site and a vehicle traveling in the periphery of the accident site.

FIG. 9 is a diagram illustrating an overview of generation of a fixed point monitoring video.

FIG. 10 is a diagram illustrating an example of accident information in a third embodiment of the present invention.

### DESCRIPTION OF EMBODIMENTS

Hereinafter, in order to explain the present invention in more detail, embodiments for carrying out the present invention will be described with reference to the accompanying drawings.

### First Embodiment

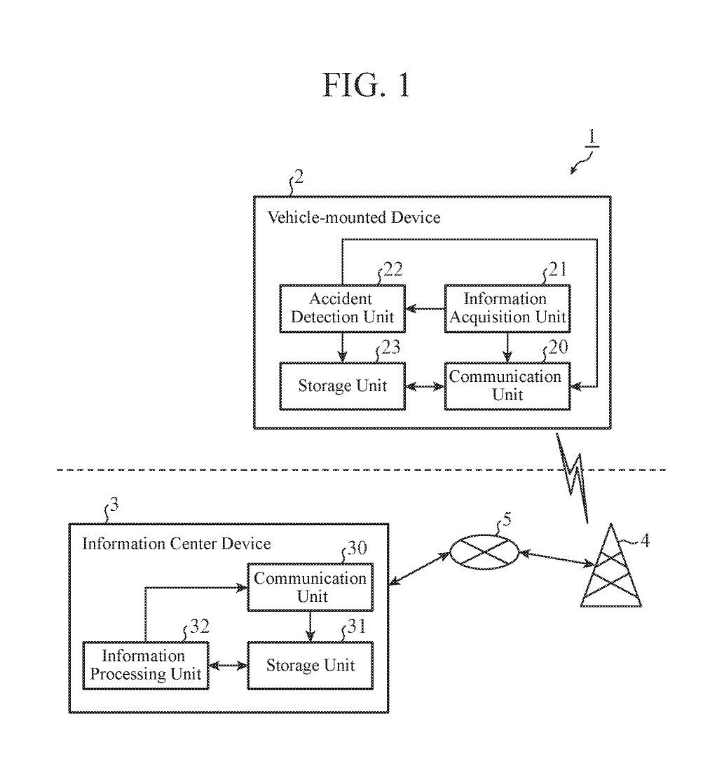

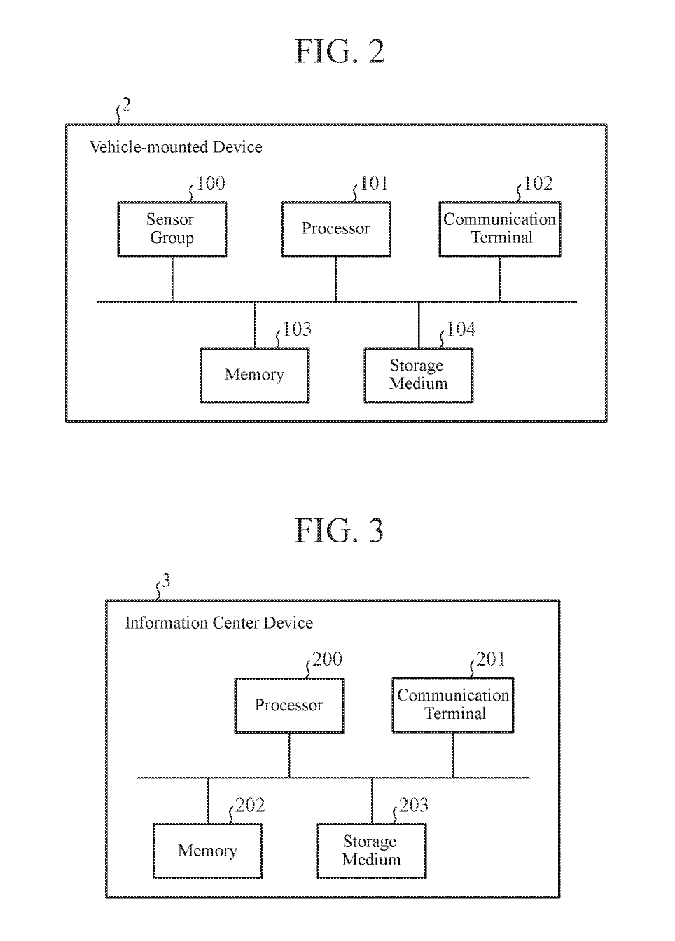

FIG. 1 is a block diagram illustrating a functional configuration of an accident information collection system 1 according to a first embodiment of the present invention. In addition, FIG. 2 is a block diagram illustrating a hardware configuration of a vehicle-mounted device 2. FIG. 3 is a block diagram illustrating a hardware configuration of an information center device 3.

The accident information collection system 1 includes the vehicle-mounted device 2 mounted on a vehicle, and the information center device 3 for collecting accident information transmitted from the vehicle-mounted device 2.

The vehicle-mounted device 2 detects an accident having occurred in the vehicle or the periphery of the vehicle, and transmits the accident information on the accident to the information center device 3. Note that, the accident information is information including location information and a video of the accident having occurred in the vehicle or the periphery of the vehicle.

In addition, in the example illustrated in FIG. 1, the vehicle-mounted device 2 and the information center device 3 are connected together by a network 5 via a radio base station 4.

Note that, the vehicle-mounted device 2 and the information center device 3 may be communicatively connected together by inter-vehicle communication via a vehicle-mounted communication device, or may be communicatively connected together via a communication device installed on the roadside.

The vehicle-mounted device 2 includes a communication unit 20, an information acquisition unit 21, an accident detection unit 22, and a storage unit 23.

The communication unit 20 communicates with the information center device 3 via the radio base station 4 and the network 5. For example, the communication unit 20 transmits the accident information to the information center device 3 in accordance with control from the accident detection unit 22. In addition, when a transmission instruction of the accident information is received from the information center device 3, the communication unit 20 returns the accident information to the information center device 3 regardless of the control from the accident detection unit 22. At this time, the communication unit 20 stores the accident information in the storage unit 23.

The information acquisition unit 21 acquires information on a vehicle state and a situation of the periphery of the vehicle. For example, the information is acquired from a vehicle-mounted camera, an acceleration sensor, a global positioning system (GPS) receiver, a vehicle control device, and the like. The vehicle-mounted camera captures a video of the periphery of the vehicle. The acceleration sensor detects acceleration in the front-back direction generated in the vehicle. The GPS receiver analyzes GPS information received from GPS satellites and detects the time information and the location information of the vehicle. In addition, the information acquisition unit 21 acquires driving operation information such as a vehicle speed, a steering angle, and brake information from the vehicle control device.

On the basis of the information acquired by the information acquisition unit 21, the accident detection unit 22 detects the accident having occurred in the vehicle or the periphery of the vehicle. For example, the accident detection unit 22 determines that the accident has occurred in the vehicle when the acceleration or the brake state exceeds a threshold value, and determines that the accident has occurred in the periphery of the vehicle from an analysis result of the video of the periphery of the vehicle. In addition, the accident detection unit 22 generates accident information on the accident having occurred in the vehicle or the periphery of the vehicle. When the accident information is generated, the accident detection unit 22 instructs a communication unit 30 to transmit the accident information to the information center device 3.

The storage unit 23 stores the accident information generated by the accident detection unit 22.

The communication unit 20 in the vehicle-mounted device 2 communicates using a communication terminal 102 illustrated in FIG. 2, and the storage unit 23 stores the information in a storage medium 104 illustrated in FIG. 2. In addition, the information acquisition unit 21 acquires information from a sensor group 100. That is, the sensor group 100 includes the vehicle-mounted camera, the acceleration sensor, the GPS receiver, and the vehicle control device described above.

In addition, individual functions of the communication unit 20, the information acquisition unit 21, the accident detection unit 22, and the storage unit 23 in the vehicle-mounted device 2 are implemented by a processing circuit. That is, the vehicle-mounted device 2 includes a processing circuit for communicating with the information center device 3, acquiring the information on the vehicle state and the situation of the periphery of the vehicle, performing detection of the accident having occurred in the vehicle or the periphery of the vehicle and generation of accident information, and instructing transmission of the accident information to the information center device 3. The processing circuit may be dedicated hardware, or a processor 101 for executing a program stored in a memory 103.

When the processing circuit is the dedicated hardware, examples of the processing circuit include a single circuit, a composite circuit, a programmed processor, a parallel-programmed processor, an application specific integrated circuit (ASIC), a field-programmable gate array (FPGA), and a combination thereof. The functions of the communication unit 20, the information acquisition unit 21, the accident detection unit 22, and the storage unit 23 may be implemented by respective processing circuits, or the functions of the units may be collectively implemented by a processing circuit.

When the processing circuit is the processor 101, the functions of the communication unit 20, the information acquisition unit 21, the accident detection unit 22, and the storage unit 23 are implemented by software, firmware, or a combination of software and firmware. The software or the firmware is described as the program and stored in the memory 103. The processing circuit reads and executes the program stored in the memory 103, thereby implementing the function of each of the units.

That is, the vehicle-mounted device 2 includes the memory 103 for storing a program that when executed by the processing circuit, resultantly executes a series of processing steps of acquiring the information on the vehicle state and the situation of the periphery of the vehicle, performing detection of the accident having occurred in the vehicle or the periphery of the vehicle and generation of accident information, on the basis of the information, and transmitting the accident information to the information center device 3.

In addition, examples of the memory 103 include a nonvolatile or volatile semiconductor memory such as a random access memory (RAM), a read only memory (ROM), a flash memory, an erasable programmable ROM (EPRROM), or an electrically erasable programmable ROM (EEPROM), a magnetic disk, a flexible disk, an optical disk, a compact disk, a mini disk, a digital versatile disc (DVD), and the like.

Note that, the functions of the communication unit 20, the information acquisition unit 21, the accident detection unit 22, and the storage unit 23 may be partially implemented by the dedicated hardware and partially implemented by the software or the firmware. For example, for the communication unit 20, its function can be implemented by a processing circuit as the dedicated hardware, and for the information acquisition unit 21, the accident detection unit 22, and the storage unit 23, a processing circuit can implement their functions by reading and executing the program stored in the memory 103.

As described above, the processing circuit can implement the above-described functions by the hardware, software, firmware, or a combination thereof.

The information center device 3 includes the communication unit 30, a storage unit 31, and an information processing unit 32.

The communication unit 30 communicates with the vehicle-mounted device 2. For example, the communication unit 30 communicatively connects to the network 5 and communicates with the communication unit 20 of the vehicle-mounted device 2 via the radio base station 4.

The storage unit 31 sequentially stores pieces of accident information received from one or more of the vehicle-mounted device 2 by the communication unit 30.

Note that, the accident information stored in the storage unit 31 can be read by the information processing unit 32 as appropriate.

The information processing unit 32 determines an accident for which accident information needs to be further collected, from among accidents indicated by pieces of accident information stored in the storage unit 31. For example, when an accident situation or an accident site included in accident information matches a predetermined condition, the corresponding accident is determined as a serious accident for which accident information needs to be further collected. Examples of the predetermined condition include whether an accident site is on an expressway, whether there is overturning or falling of a vehicle, whether a number of vehicles are involved, and whether a pedestrian or a two-wheeled vehicle is involved.

In addition, the information processing unit 32 instructs a vehicle-mounted device 2 existing in the periphery of the site of the accident determined to be the one for which accident information needs to be collected, to transmit accident information, by controlling the communication unit 30.

For example, the information processing unit 32 controls the communication unit 30 to perform simultaneous distribution of a transmission request of accident information to a communication range including the periphery of the accident site. When the transmission request of accident information is received, a vehicle-mounted device 2 determines whether or not the vehicle-mounted device 2 exists in the periphery of the accident site, on the basis of location information of the accident site included in the transmission request. Then, when existing in the periphery of the accident site, the vehicle-mounted device 2 generates and transmits accident information on the accident to the information center device 3.

Note that, in addition to transmitting the accident information, the information processing unit 32 may instruct the storage unit 23 included in the vehicle-mounted device 2 to store the accident information.

The communication unit 30 in the information center device 3 communicates using a communication terminal 201 illustrated in FIG. 3, and the storage unit 31 stores the information in a storage medium 203 illustrated in FIG. 3.

In addition, individual functions of the communication unit 30, the storage unit 31, and the information processing unit 32 in the information center device 3 are implemented by a processing circuit.

That is, the information center device 3 includes a processing circuit for receiving accident information by communicating with the vehicle-mounted device 2, storing the accident information received from the vehicle-mounted device 2, and collecting accident information from a vehicle-mounted device 2 existing in the periphery of the site of the accident indicated by the accident information stored.

The processing circuit may be dedicated hardware, or a processor 200 for executing a program stored in a memory 202.

When the processing circuit is the dedicated hardware, examples of the processing circuit include a single circuit, a composite circuit, a programmed processor, a parallel-programmed processor, an ASIC, an FPGA, and a combination thereof. The functions of the communication unit 30, the storage unit 31, and the information processing unit 32 may be implemented by respective processing circuits, or the functions of the units may be collectively implemented by a processing circuit.

When the processing circuit is the processor 200, the functions of the communication unit 30, the storage unit 31, and the information processing unit 32 are implemented by software, firmware, or a combination of software and firmware. The software or the firmware is described as the program and stored in the memory 202. The processing circuit reads and executes the program stored in the memory 202, thereby implementing the function of each of the units.

That is, the information center device 3 includes the memory 202 for storing a program that when executed by the processing circuit, resultantly executes a series of processing steps of receiving accident information by communicating with the vehicle-mounted device 2, storing the accident information received from the vehicle-mounted device 2, and collecting accident information from a vehicle-mounted device 2 existing in the periphery of the site of the accident indicated by the accident information stored in the storage unit 31, by controlling the communication unit 30. In addition, the memory 202 is similar to the memory 103 described above.

Note that, the functions of the communication unit 30, the storage unit 31, and the information processing unit 32 may be partially implemented by the dedicated hardware and partially implemented by the software or the firmware. For example, for the communication unit 30, its function can be implemented by a processing circuit as the dedicated hardware, and for the storage unit 31 and the information processing unit 32, a processing circuit can implement their functions by reading and executing the program stored in the memory 202.

As described above, the processing circuit can implement the above-described functions by the hardware, software, firmware, or a combination thereof.

Next, the operation will be described.

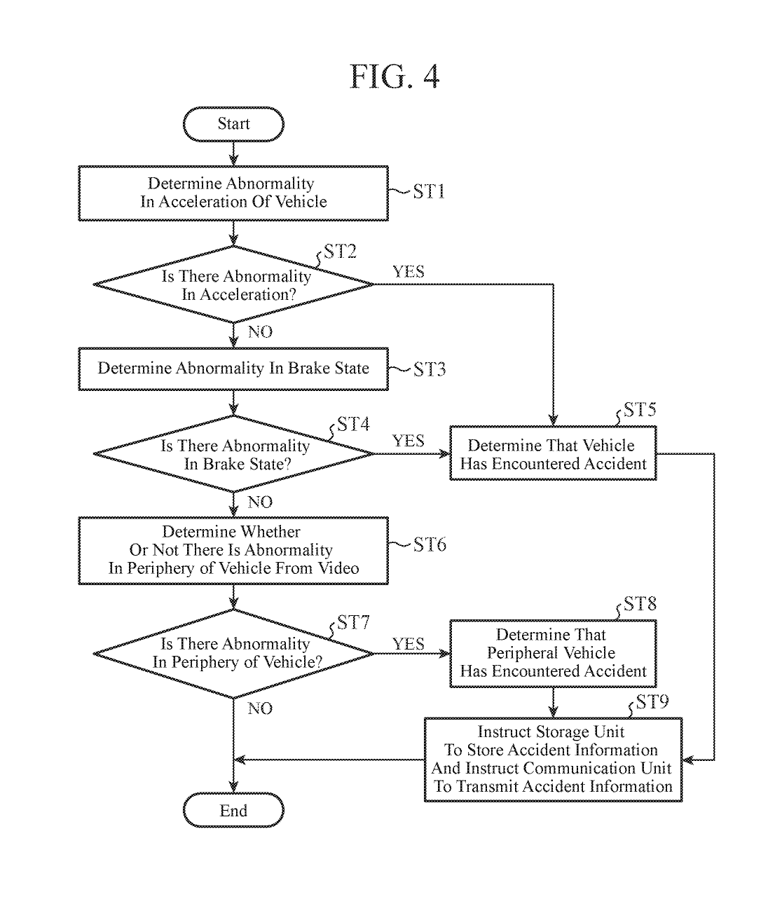

FIG. 4 is a flowchart illustrating the operation of the vehicle-mounted device 2, and illustrates a series of processing steps of detecting an accident in the vehicle or the periphery of the vehicle and transmitting the corresponding accident information to the information center device 3.

First, the information acquisition unit 21 continuously acquires information on the vehicle state and the situation of the periphery of the vehicle from the sensor group 100 at certain intervals, such as 30 times per second. The information is successively output from the information acquisition unit 21 to the accident detection unit 22.

The accident detection unit 22 determines an abnormality in the acceleration of the vehicle acquired by the information acquisition unit 21 (step ST1). For example, when the acceleration applied in the front-back direction of the vehicle exceeds a predetermined threshold value, it is determined that the vehicle has encountered an accident and thus acceleration that cannot be generated in normal driving has been generated.

When it is determined that there is no abnormality in the acceleration of the vehicle (step ST2; NO), the accident detection unit 22 determines whether or not there is an abnormality in a brake state of the vehicle acquired by the information acquisition unit 21 (step ST3). For example, when the brake strength exceeds a predetermined threshold value, it is determined that the vehicle has encountered an accident and thus a sudden braking maneuver that cannot be performed in normal driving has been performed.

On the other hand, when it is determined that there is an abnormality in the acceleration of the vehicle (step ST2; YES) or when it is determined that there is an abnormality in the brake state of the vehicle (step ST4; YES), the accident detection unit 22 determines that the vehicle has encountered an accident (step ST5).

When it is determined that there is no abnormality in the brake state of the vehicle (step ST4: NO), the accident detection unit 22 determines whether or not there is an abnormality in the periphery of the vehicle from the video of the periphery of the vehicle acquired by the information acquisition unit 21 (step ST6).

As a method of determining whether or not there is an abnormality from the video of the periphery of the vehicle, for example, it is conceivable to use machine learning. In the machine learning, a discriminator is provided that has learned videos of accidents each of which has occurred in the periphery of a vehicle. The accident detection unit 22 inputs the video of the periphery of the vehicle to the discriminator, and the discriminator discriminates whether or not an accident occurs in the video. The discriminator is stored in the memory 103.

In addition, a discriminator may be used that has learned videos each of which shows that no abnormality has occurred in the periphery of a vehicle.

When it is determined that there is no abnormality in the periphery of the vehicle (step ST7; NO), the processing is ended.

On the other hand, when it is determined that there is an abnormality in the periphery of the vehicle (step ST7; YES), the accident detection unit 22 determines that a peripheral vehicle has encountered an accident (step ST8).

When it is determined that the vehicle has encountered an accident in step ST5, or when it is determined that the peripheral vehicle has encountered an accident in step ST8, the accident detection unit 22 generates accident information on the accident, and instructs the communication unit 20 to transmit the accident information to the information center device 3. The communication unit 20 transmits the accident information to the information center device 3 in accordance with the instruction of the accident detection unit 22.

Further, the accident detection unit 22 instructs the storage unit 23 to store the accident information. As a result, the storage unit 23 stores the accident information generated by the accident detection unit 22.

The processing so far corresponds to step ST9. Note that, when the vehicle-mounted device 2 does not include the storage unit 23, the accident detection unit 22 performs only an instruction to the communication unit 20 in step ST9.

In the example of FIG. 4, the case has been described where the acceleration generated in the vehicle and the brake state are sequentially determined; however, it is not always necessary to make the determination in this order. In addition, it may be determined whether the vehicle has encountered an accident from acceleration, a sudden change in the vehicle speed other than in the brake state, activation of the airbag, a sudden change in the steering angle, or the like.

In addition, in FIG. 4, the case has been described where whether or not there is an abnormality in the periphery of the vehicle is determined after it is determined whether or not the vehicle has encountered an accident; however, this is not a limitation.

That is, the processing of determining whether or not there is an abnormality in the periphery of the vehicle and the processing of determining whether or not the vehicle has encountered an accident may be executed in parallel with each other.

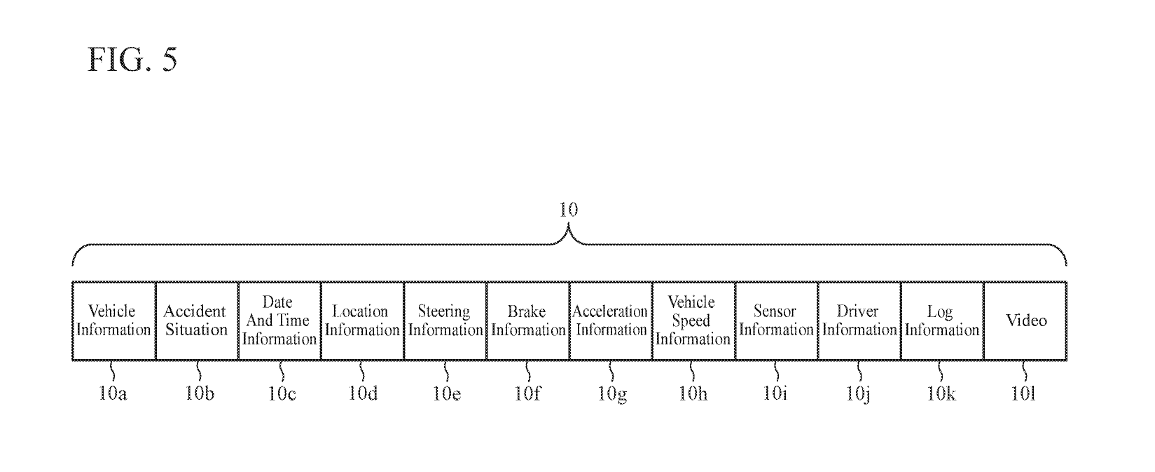

FIG. 5 is a diagram illustrating an example of accident information 10 in the first embodiment. The accident detection unit 22 generates the accident information 10 on an accident having occurred in the vehicle or the periphery of the vehicle from the information acquired by the information acquisition unit 21. Here, as illustrated in FIG. 5, the accident information 10 includes, for example, vehicle information 10a, an accident situation 10b, date and time information 10c, location information 10d, steering information 10e, brake information 10f, acceleration information 10g, vehicle speed information 10h, sensor information 10i, driver information 10j, log information 10k, and a video 10l.

The vehicle information 10a is information for specifying a vehicle on which the vehicle-mounted device 2 is mounted, and is, for example, license plate information of the vehicle, or a unique ID allocated to the vehicle or the vehicle-mounted device 2.

The accident situation 10b is information indicating whether the vehicle has encountered an accident or the peripheral vehicle has encountered an accident. In addition, a detailed situation of the accident is also included, such as whether there is overturning or falling of a vehicle, whether a number of vehicles are involved, or whether a pedestrian or a two-wheeled vehicle is involved.

The date and time information 10c indicates the date and time when the accident information 10 has been transmitted to the information center device 3 or the date and time when the accident has been encountered. In addition, it may be the date and time when the accident information 10 has been stored in the storage unit 23. Further, when the accident information 10 is continuously generated within a certain period and is stored in the storage unit 23, the storage start date and time and the storage end date and time may be included in the date and time information 10c.

The location information 10d is information indicating a location (latitude and longitude, or the like) of a place where the accident information 10 is transmitted to the information center device 3, and is information indispensable for the accident information 10. Note that, the location information 10d may be a location of a place where the storage unit 23 has stored the accident information 10.

The information center device 3 specifies a location of the accident site from the location information 10d.

The steering information 10e is information indicating a change in the steering angle of the steering wheel, and is acquired continuously for a certain period by the information acquisition unit 21. The steering information 10e includes, for example, information at the time when the accident has occurred and information before and after the accident. In addition, the brake information 10f is information indicating the brake state (brake strength), and is acquired continuously for a certain period by the information acquisition unit 21. The brake information 10f includes, for example, information at the time when the accident has occurred and information before and after the accident.

The acceleration information 10g is information indicating the acceleration generated in the vehicle, and is acquired continuously for a certain period by the information acquisition unit 21. The acceleration information 10g includes, for example, information at the time when the accident has occurred and information before and after the accident. The vehicle speed information 10h is information indicating the speed of the vehicle, and is acquired continuously for a certain period by the information acquisition unit 21. The vehicle speed information 10h includes, for example, information at the time when the accident has occurred and information before and after the accident.

The sensor information 10i is information indicating the specifications and the mounting positions in the vehicle of the sensors mounted on the vehicle, that is, the sensor group 100. For example, information such as the specification and the mounting position of the camera is included. In addition, the driver information 10j is information indicating a state and personal information of a driver of the vehicle. The state of the driver is a biological state of the driver, and includes, for example, the direction of the face, the heart rate, and the like. The state of the driver is a result obtained by the sensor group 100 sensing the driver continuously for a certain period. In addition, the personal information of the driver includes, for example, the sex and age of the driver.

The log information 10k is information indicating a detection log of the sensor group 100 mounted in the vehicle. The log information 10k includes, for example, information at the time when the accident has occurred and information before and after the accident.

The video 10l is a video of the periphery of the vehicle captured by the camera mounted on the vehicle in the sensor group 100, and is information indispensable for the accident information 10. The video of the camera is acquired continuously for a certain period by the information acquisition unit 21, and the video 10l includes information at the time when the accident has occurred and information before and after the accident. For example, the video 10l is a video for 1 minute in which a video for 30 seconds from immediately before the accident to the occurrence of the accident and a video for 30 seconds after the occurrence of the accident are combined together.

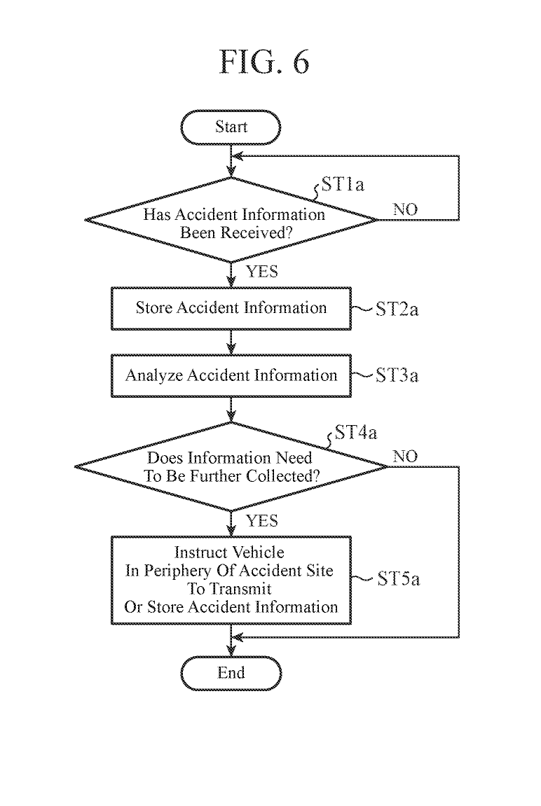

FIG. 6 is a flowchart illustrating the operation of the information center device 3, and illustrates a series of processing steps of receiving accident information from the vehicle-mounted device 2 and further collecting accident information from a vehicle-mounted device 2 existing in the periphery of the accident site.

First, while the information center device 3 is activated, the communication unit 30 always accepts accident information from the vehicle-mounted device 2. That is, if accident information is not received (step ST1a; NO), the processing of step ST1a is repeated.

When accident information is received from the vehicle-mounted device 2 (step ST1a; YES), the communication unit 30 outputs the accident information to the storage unit 31. The storage unit 31 stores the accident information received by the communication unit 30 (step ST2a). For example, the accident information is stored in the storage medium 203.

Next, the information processing unit 32 analyzes pieces of accident information stored in the storage unit 31, and determines an accident for which accident information needs to be further collected, from among accidents indicated by the pieces of accident information stored in the storage unit 31 (Step ST3a).

For example, the information processing unit 32 specifies the location of the accident site from the location information 10d included in the accident information 10, and performs image analysis of the video 10l to specify the accident situation. Then, when the accident site or the accident situation matches a predetermined condition, the information processing unit 32 determines that the corresponding accident is a serious accident for which accident information needs to be further collected. As described above, examples of the predetermined condition include whether an accident site is on an expressway, whether there is overturning or falling of a vehicle, whether a number of vehicles are involved, and whether a pedestrian or a two-wheeled vehicle is involved.

Here, when accident information does not need to be further collected (step ST4a; NO), the processing is ended. In addition, when it is determined that accident information needs to be further collected (step ST4a; YES), the information processing unit 32 instructs a vehicle-mounted device 2 existing in the periphery of the accident site to transmit accident information by controlling the communication unit 30 (step ST5a).

For example, the information processing unit 32 generates a transmission request for accident information, the transmission request including a site location of the accident for which accident information needs to be further collected and information requesting accident information on the accident.

Then, the information processing unit 32 instructs the communication unit 30 to perform simultaneous distribution of the transmission request of accident information to a communication range including the site location of the accident.

As a result, on the basis of the location information of the accident site included in the transmission request, a vehicle-mounted device 2 determines whether or not the vehicle-mounted device 2 is in the periphery of the accident site. When existing in the periphery of the accident site, the vehicle-mounted device 2 generates and transmits accident information on the accident to the information center device 3.

Note that, in addition to transmitting the accident information, the information processing unit 32 may instruct the storage unit 23 included in the vehicle-mounted device 2 to store the accident information.

As described above, in the accident information collection system 1 according to the first embodiment, the information center device 3 collects accident information from a vehicle existing in the periphery of the accident site in addition to a vehicle having directly encountered the accident. As a result, videos of various viewpoints of a traffic accident can be collected.

In addition, since accident videos of various viewpoints can be obtained as accident information, a party concerned or a third party organization can accurately grasp the accident situation.

Further, since accident information on an accident encountered by a peripheral vehicle is also collected, even when the vehicle-mounted device 2 is not mounted on the peripheral vehicle, accident information can be collected from a vehicle existing in the periphery of the accident site.

In addition, in the accident information collection system 1 according to the first embodiment, the communication unit 30 of the information center device 3 receives from the vehicle-mounted device 2 the accident information 10 which further includes, in addition to the location information 10d and the video 10l, at least one of the vehicle information 10a, the accident situation 10b, the date and time information 10c, the steering information 10e, the brake information 10f, the acceleration information 10g, the vehicle speed information 10h, the sensor information 10i, the driver information 10j, and the log information 10k.

As a result, in addition to the location information and the video of the accident site, information can also be obtained on the vehicle and the periphery of the vehicle, the sensor, and the driving state, so that the party concerned or the third party organization can accurately grasp the information on the accident.

Further, in the accident information collection system 1 according to the first embodiment, the accident detection unit 22 of the vehicle-mounted device 2 detects occurrence of an accident in the periphery of the vehicle, on the basis of the video in which the periphery of the vehicle is captured. As a result, even when the camera is not mounted on a vehicle having directly encountered the accident, the vehicle-mounted device 2 existing in the periphery of the vehicle can detect the accident of the vehicle. Since the accident information obtained in this way is transmitted from the vehicle-mounted device 2 to the information center device 3, the accident information can be surely collected.

### Second Embodiment

In an accident information collection system according to a second embodiment, an information center device generates a video in which an accident site is captured from a certain direction, on the basis of videos of the same accident included in a respective plurality of pieces of accident information stored in a storage unit. That is, a pseudo fixed point monitoring video can be obtained.

A vehicle-mounted device and the information center device in the second embodiment are similar to the configuration illustrated in FIG. 1, but are different therefrom in that an information processing unit of the information center device generates the fixed point monitoring video.

Therefore, hereinafter, a configuration of the vehicle-mounted device and the information center device in the second embodiment will be described with reference to FIG. 1.

Next, the operation will be described.

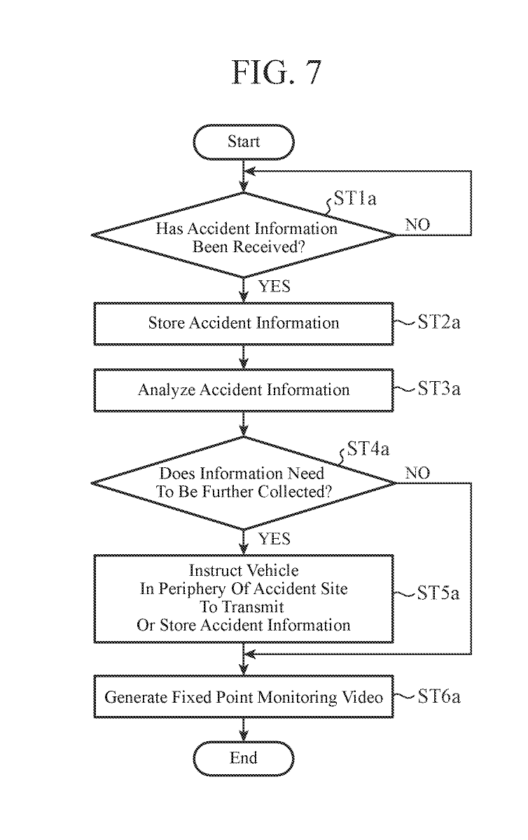

FIG. 7 is a flowchart illustrating the operation of the information center device 3 in the second embodiment, and illustrates a series of processing steps of receiving pieces of accident information from respective vehicle-mounted devices 2 and generating a pseudo fixed point monitoring video of an accident site. Note that, since the processing from step ST1a to step ST5a in FIG. 7 is the same as that in FIG. 6, the description will be omitted.

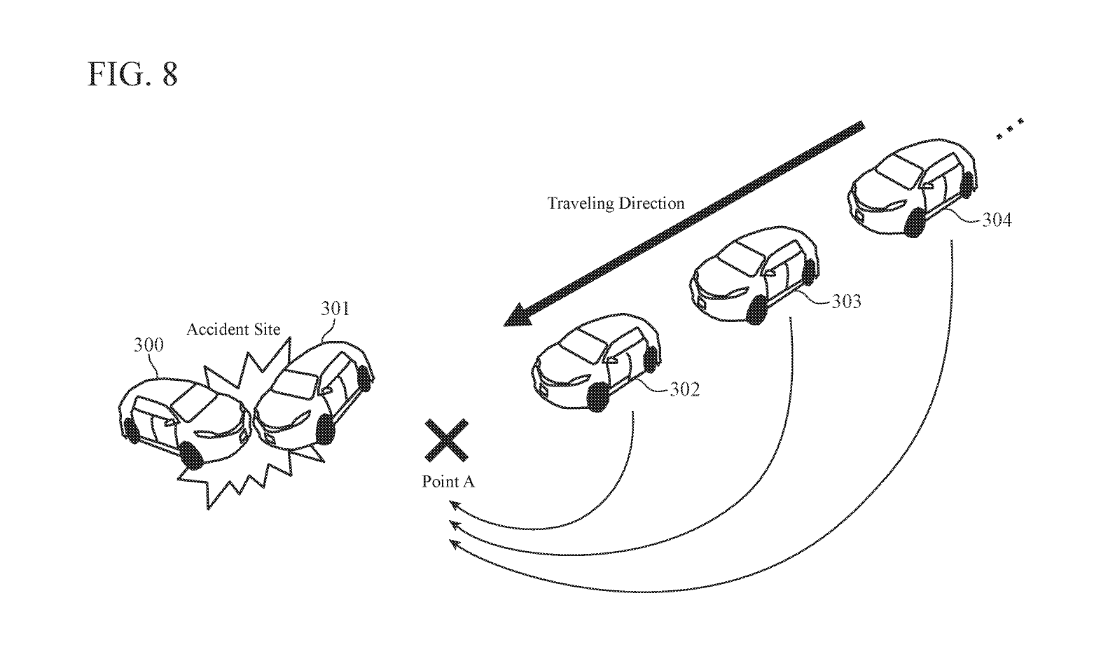

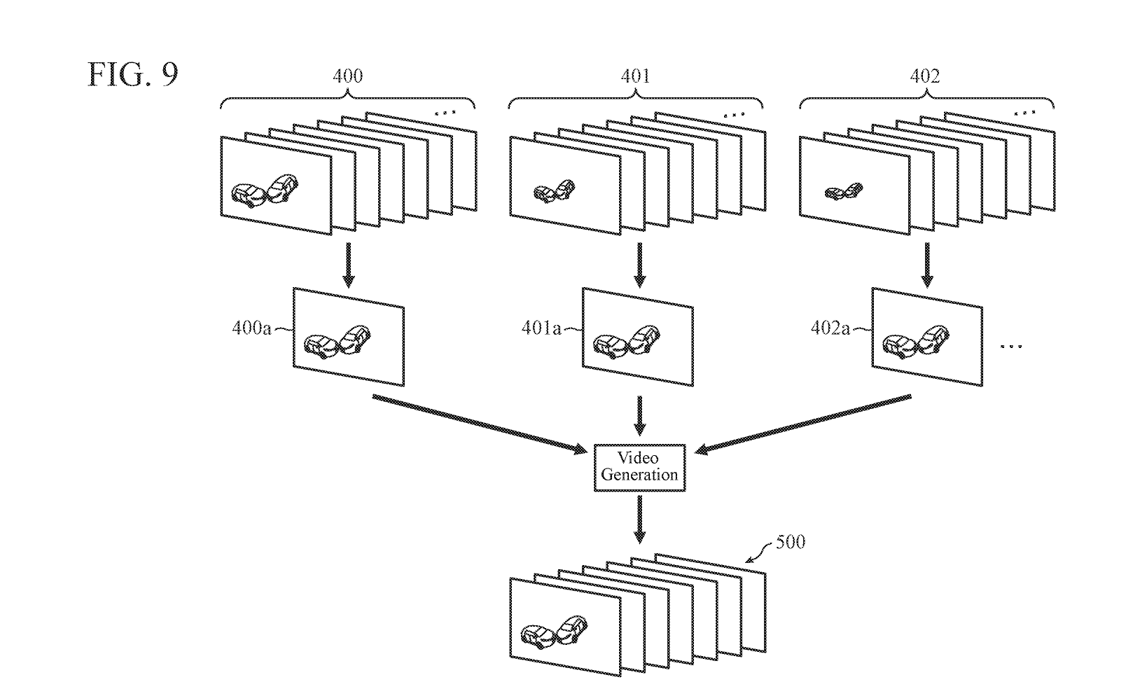

In addition, FIG. 8 is a diagram illustrating a relationship between an accident site and a vehicle traveling in the periphery of the accident site. FIG. 9 is a diagram illustrating an overview of generation of the fixed point monitoring video.

In step ST6a, the information processing unit 32 generates a pseudo fixed point monitoring video on the basis of videos of the same accident included in a respective plurality of pieces of accident information stored in the storage unit 31.

As illustrated in FIG. 8, as an example, a case will be described where, at a point A located in the periphery of a site of an accident caused by a vehicle 300 and a vehicle 301, a vehicle 302 arrives at time t1, a vehicle 303 arrives at time t2 later than the time t1, and a vehicle 304 arrives at time t3 later than the time t2.

The vehicle-mounted device 2 mounted on each of the vehicle 302, the vehicle 303, and the vehicle 304 detects the accident. At this time, as illustrated in FIG. 9, the vehicle-mounted device 2 mounted on the vehicle 302 generates accident information including a video 400 of the accident and location information of the point A, and transmits the accident information to the information center device 3.

Next, the vehicle-mounted device 2 mounted on the vehicle 303 generates accident information including a video 401 of the accident and the location information of the point A, and transmits the accident information to the information center device 3. Further, the vehicle-mounted device 2 mounted on the vehicle 304 generates accident information including a video 402 of the accident and the location information of the point A, and transmits the accident information to the information center device 3. Note that, the vehicle-mounted device 2 mounted on another vehicle arriving at the point A after the vehicle 304 having passed through the point A also similarly transmits accident information to the information center device 3.

The information processing unit 32 of the information center device 3 extracts a frame image 400a at the time t1 when the vehicle 302 arrives at the point A, from the video 400 included in the corresponding accident information received by the communication unit 30. Next, similarly, the information processing unit 32 extracts a frame image 401a at the time t2 when the vehicle 303 arrives at the point A, from the video 401, and extracts a frame image 402a at the time t3 when the vehicle 304 arrives at the point A, from the video 402. The information processing unit 32 repeats the same processing for videos from other vehicles arriving at the point A following the vehicle 304.

In this way, the information processing unit 32 sequentially acquires the frame images of the accident site captured at the point A. By arranging the frame images in chronological order, a pseudo fixed point monitoring video 500 can be obtained.

However, a time interval between the frame images in the fixed point monitoring video 500 varies depending on a positional relationship between the corresponding vehicles. In addition, depending on the mounting position of the camera in the vehicle and the specification of the camera, a position and a size of a subject, an image characteristic, and the like in the frame image may vary.

For this reason, simply arranging the frame images extracted as described above in chronological order may result in an unnatural video even when the frame images of the fixed point monitoring video are continuously reproduced.

Therefore, the information processing unit 32 corrects the frame images extracted as described above to obtain a natural video when the frame images of the fixed point monitoring video are continuously reproduced.

For example, the information processing unit 32 specifies the mounting position and specification of the camera from the sensor information 10i included in each accident information 10, and thus corrects differences in position and size of the corresponding subject and a difference in image characteristic between the frame images. In addition, correction may be performed by matching feature points with each other between the frame images so that a positional relationship between the feature points becomes appropriate.

Further, a frame image at missing time may be interpolated by correcting one frame image or by synthesizing a plurality of frame images so that the time intervals of the frame images become uniform.

In addition, in the vehicle-mounted devices 2 mounted on a respective plurality of vehicles, capturing ranges of respective cameras are often different from each other.

Therefore, the information processing unit 32 may extract frame images for each same time from a respective plurality of accident information videos, and spatially connect the frame images together to sequentially synthesize frame images. By performing such so-called panorama synthesis, a video is generated indicating the accident site in a wider range than the video captured by the camera of each vehicle.

As described above, in the accident information collection system 1 according to the second embodiment, the information processing unit 32 generates a video indicating the accident temporally or spatially continuously, on the basis of the videos of the same accident included in the respective plurality of pieces of accident information stored in the storage unit 31.

By generating the video indicating the accident temporally continuously in this way, a video can be provided in which fixed point monitoring of the accident site is performed continuously for a certain period. As a result, the party concerned and the third party organization can accurately grasp changes over time at the accident site.

In addition, by generating the video indicating the accident spatially continuously, a video can be provided in which the accident site is panoramically captured. As a result, the party concerned and the third party organization can accurately grasp the situation of the accident site.

### Third Embodiment

A vehicle-mounted device and an information center device in a third embodiment are similar to the configuration illustrated in FIG. 1, but are different therefrom in that the vehicle-mounted device and the information center device exchange a hash value.

Therefore, hereinafter, a configuration of the vehicle-mounted device and the information center device in the third embodiment will be described with reference to FIG. 1.

The hash value is a value obtained by performing arithmetic processing of a hash function on target data.

As hash functions, functions such as SHA-1, SHA-2, and MD5 are known. The data size of the hash value is much smaller than that of the target data. In addition, hash values obtained from the same target data by arithmetic operation with the same hash function are the same value, and when hash functions or pieces of target data are different from each other, hash values obtained thereby are also different values.

By using this feature, it is possible to confirm whether or not accident information has been tampered with when the accident information is transmitted and received.

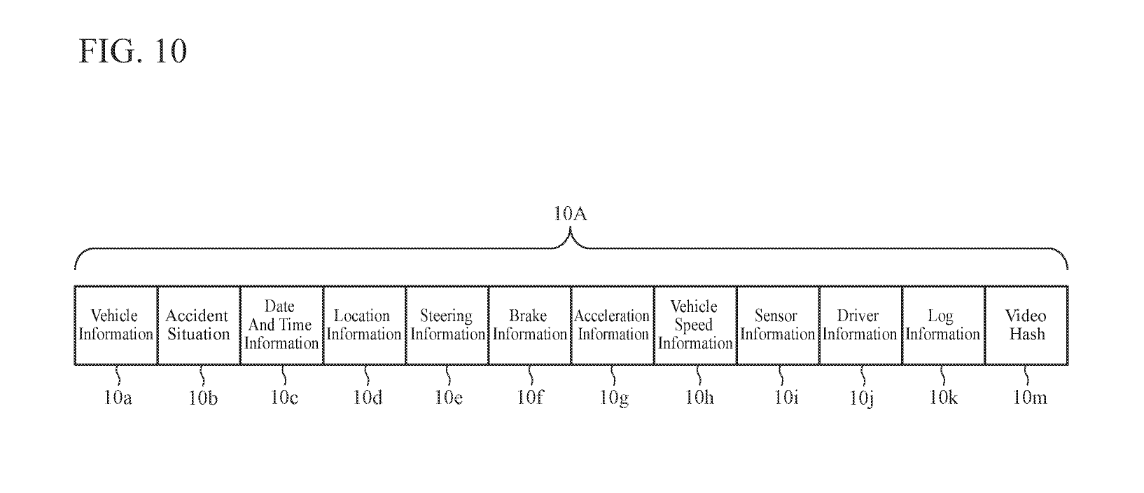

FIG. 10 is a diagram illustrating an example of accident information 10A in the third embodiment of the present invention. In the accident information 10A illustrated in FIG. 10, the video 10l of the accident information 10 illustrated in FIG. 5 is replaced by a video hash 10m.

The video hash 10m is a value obtained by performing arithmetic processing of the hash function on video data of an accident. Note that, hash values may be generated from, in addition to the video data, one or more pieces of information among the multiple pieces of information constituting the accident information 10A illustrated in FIG. 10.

When an accident having occurred in the vehicle or the periphery of the vehicle is detected, the vehicle-mounted device 2 generates a hash value from the video data of the accident, for example, and transmits the hash value as accident information to the information center device 3. For example, when a vehicle on which the vehicle-mounted device 2 is mounted encounters an accident, there is a possibility that the communication unit 20 malfunctions due to an impact of the accident or the like, and thereby an amount of information that can be communicated is reduced. Even in this case, the hash value having a small data size can be accurately transmitted to the information center device 3.

After the hash value is transmitted, the vehicle-mounted device 2 transmits raw data of the accident information to the information center device 3 with reception of a transmission request from the police or the like as a trigger.

The information processing unit 32 of the information center device 3 generates a hash value from the accident information received later and compares the hash value with the previously received hash value to confirm whether or not both hash values coincide with each other. As a result, it is possible to confirm whether or not the accident information has been tampered with.

As described above, in the accident information collection system 1 according to the third embodiment, the communication unit 20 of the vehicle-mounted device 2 generates a hash value from the accident information and transmits the hash value as accident information to the information center device 3. Since only the hash value of the accident information is transmitted as described above, the communication load of the accident information is greatly reduced as compared with a case where the video itself is transmitted, and transmission failure of the accident information can be reduced.

The communication unit 30 of the information center device 3 receives the hash value generated from the accident information by the vehicle-mounted device 2. The information processing unit 32 determines whether or not the accident information has been tampered with, on the basis of a result of comparing the hash value received by the communication unit 30 with the hash value generated from the accident information received by the communication unit 30. As a result, it is possible to ensure admissibility of evidence of the accident video.

Note that, in the present invention, within the scope of the invention, free combination of the embodiments, a modification of any component of each embodiment, or omission of any component in each embodiment is possible.

### INDUSTRIAL APPLICABILITY

Since the accident information collection system according to the present invention can collect videos of various viewpoints of a traffic accident, it is suitable for an emergency notification system for making an emergency call on the basis of accident information.

### REFERENCE SIGNS LIST

1 Accident information collection system
2 Vehicle-mounted device
3 Information center device
4 Radio base station
5 Network
10, 10A Accident information
10a Vehicle information
10b Accident situation
10c Date and time information
10d Location information
10e Steering information
10f Brake information
10g Acceleration information
10h Vehicle speed information
10i Sensor information
10j Driver information
10k Log information
10l Video
10m Video hash
20, 30 Communication unit
21 Information acquisition unit
22 Accident detection unit
23, 31 Storage unit
32 Information processing unit
100 Sensor group
101, 200 Processor
102, 201 Communication terminal
103, 202 Memory
104, 203 Storage medium
300 to 304 Vehicle
400 to 402 Video
400a to 402a Frame image
500 Fixed point monitoring video.

1-8. (canceled)

9. An accident information collection system comprising:
a processor to execute a program; and
a memory to store the program which, when executed by the processor, performs processes of,
communicating with one or more vehicle-mounted devices each configured to generate accident information including information indicating a location and a video of an accident having occurred in a vehicle or a periphery of the vehicle;
storing accident information received from at least one of the vehicle-mounted devices; and
collecting accident information from at least another one of the vehicle-mounted devices existing in a periphery of a site of an accident indicated by the accident information stored,
wherein the processes include:
extracting frame images from videos of a site of an identical accident included in a respective plurality of pieces of accident information stored;
correcting, for the extracted frame images, one or more of a difference in subject position, a difference in subject size, and a difference in image characteristic, the differences being caused between the frame images of the videos by a difference in position of corresponding vehicles and a difference in cameras attached to the respective vehicles;
performing interpolation for adjusting a time interval between the frame images in the videos; and
thereby generating a video indicating the accident temporally or spatially continuously.

10. The accident information collection system according to claim 9, wherein the processes include:
receiving a hash value generated from accident information by at least one of the vehicle-mounted devices, and
determining whether or not the accident information has been tampered with, on a basis of a result of comparing the hash value received with a hash value generated from accident information received.

11. The accident information collection system according to claim 9, wherein the processes include:
receiving from at least one of the vehicle-mounted devices accident information further including at least one of: unique information for identifying a vehicle, information indicating an accident situation, date and time information when an accident has occurred, steering information of the vehicle, brake information of the vehicle, acceleration information of the vehicle, vehicle speed information, sensor information indicating a specification and a mounting position of a sensor mounted on the vehicle, personal information of a driver, and log information indicating a detection log of the sensor.

12. The accident information collection system according to claim 9, wherein each of the vehicle-mounted devices comprises:
a processor to execute a program; and
a memory to store the program which, when executed by the processor, performs processes of,
communicating with an information center device configured to collect accident information including information indicating a location and a video of an accident having occurred in a vehicle or a periphery of the vehicle;
acquiring information on a state of a vehicle and a situation of a periphery of the vehicle; and
performing detection of an accident having occurred in the vehicle or the periphery of the vehicle and generation of accident information, on a basis of the information acquired, and transmitting the accident information to the information center device.

13. The accident information collection system according to claim 12, wherein the detection includes detecting occurrence of the accident in the periphery of the vehicle, on a basis of a video in which the periphery of the vehicle is captured.

14. The accident information collection system according to claim 12, wherein the processes include generating a hash value from the accident information and transmitting the hash value as accident information to the information center device.

15. An accident information collection method comprising:
communicating with one or more vehicle-mounted devices each configured to generate accident information including information indicating a location and a video of an accident having occurred in a vehicle or a periphery of the vehicle;
storing accident information received from at least one of the vehicle-mounted devices; and
collecting accident information from at least another one of the vehicle-mounted devices existing in a periphery of a site of an accident indicated by the accident information stored,
wherein the method includes:
extracting frame images from videos of a site of an identical accident included in a respective plurality of pieces of accident information stored;
correcting, for the extracted frame images, one or more of a difference in subject position, a difference in subject size, and a difference in image characteristic, the differences being caused between the frame images of the videos by a difference in position of corresponding vehicles and a difference in cameras attached to the respective vehicles;
performing interpolation for adjusting a time interval between the frame images in the videos; and
thereby generating a video indicating the accident temporally or spatially continuously.
